(19) United States
(12) Patent Application Publication
(10) Pub. No.: US 2017/0328536 A1
(43) Pub. Date: Nov. 16, 2017

(54) MULTIPLAYERED IMAGE TRANSMITTING LAMPSHADE MANUFACTURING PROCESS AND PRODUCT THEREOF

(71) Applicant: Jian-Ming Chen, Shenzhen (CN)

(72) Inventor: Jian-Ming Chen, Shenzhen (CN)

(21) Appl. No.: 15/152,563

(22) Filed: May 12, 2016

(51) Int. Cl. F21V 1/12; F21V 1/26; F21W 121/00

(52) U.S. Cl. CPC F21V 1/12; F21V 1/26; F21W 2121/00

(57) ABSTRACT

Disclosed is a multilayered image transmitting lampshade manufacturing process and a product thereof. The manufacturing process includes forming, on an inside surface of a hollow light-transmitting lampshade made of light-transmitting glass or light-transmitting plastics, a non-transparent electroplated coating film, using a laser engraving machine to engrave at least one hollowed zone having different shapes and sizes in the non-transparent electroplated coating layer, and finally, conducting nano-coating to form a semi-transparent coating film on an outside surface of the lampshade. The product includes a hollow light-transmitting lampshade having an inside surface coated with a non-transparent electroplated coating layer that is machined with a laser engraving machine to form at least one hollowed zone constituting a pattern and also includes glue applied to fix glitter or light-transmitting color paint between the inside surface of the lampshade and the non-transparent electroplated coating layer, and further includes a semi-transparent nano coating film.

### (a) TECHNICAL FIELD OF THE INVENTION

The present invention relates generally to a technique of managing light, and more particularly to a manufacturing process of a hollow decorative lampshade or cover shows a multilayered image transmission effect and a product thereof.

### (b) DESCRIPTION OF THE PRIOR ART

People often purchase and set up art products, standing decorations, suspending decorations, or light decoration and lighting fixtures in their household or office places. Conventional light decorations only have the function of light emission and display just planar patterns or images.

### SUMMARY OF THE INVENTION

To make lighting fixture products more visual appealing, an object of the present invention is to provide a glass or plastic lampshade or cover product that, without modifying an original structure of an existing lighting device, provides an exquisite appearance, allows for exchange with different configurations, and shows a planar image formed of multiple layers of different patterns.

The present invention provides a multilayered image transmitting lampshade manufacturing process and a product thereof, wherein the manufacturing process is such that the an operation is conducted on an inside surface of a hollow light-transmitting lampshade formed of light-transmitting glass or light-transmitting plastics to form a non-transparent electroplated coating film; a laser engraving machine is used to engrave, in the non-transparent electroplated coating layer, at least one hollowed zone having different shape and size; and finally, nano-coating is applied to an outside surface of the lampshade to form a semi-transparent or partially transparent or transparent electroplated coating film.

The present invention provides a multilayered image transmitting lampshade manufacturing process and a product thereof, wherein the product comprises a hollow light-transmitting lampshade (1) that is formed of light-transmitting glass or light-transmitting plastics and the lampshade (1) has an inside surface coated with a non-transparent electroplated coating film (11) such that the non-transparent electroplated coating layer (11) is engraved with a laser engraving machine to form at least one hollowed zone (12) that constitutes a pattern and also comprises glitter or light-transmitting color paint (13) disposed and fixed, by glue or adhesive, between the inside surface of the lampshade (1) and the non-transparent electroplated coating layer (11) and further comprises a semi-transparent or partially transparent or transparent electroplated coating film (14) formed on an outside surface of the lampshade (1).

The lampshade manufactured with such as manufacturing process has a surface that constitutes a shade and provides an effect of showing a multilayered planar image exhibited through light illumination and transmission. The thickness of the glass or light-transmitting plastics and nanometer coating films on the inside and outside surfaces, in combination with differences of light transmittance properties and refractive indexes, as well as laser engraved patterns formed on the inside surface, help form an effect of multiple layer image formation, while the glitter or the light-transmitting color paint provides an additional effect of eye catching.

The technical issue to be addressed in the present invention is to provide a hollow decorative lampshade showing an effect of multilayered image formation, which overcomes the insufficiency of multilayer image effect in the prior art lampshades and can be manufactured at a low cost and has a simple structure.

To resolve such an issue, the present invention provides a product that comprises a hollow decorative lampshade showing an effect of multilayered image formation and comprising a hollow light-transmitting lampshade that is formed of light-transmitting glass or light-transmitting plastics and the lampshade has an inside surface coated with a non-transparent electroplated coating film such that the non-transparent electroplated coating layer is engraved with a laser engraving machine to form at least one hollowed zone that constitutes a pattern and also comprises glitter or light-transmitting color paint disposed and fixed, by glue or adhesive, between the inside surface of the lampshade and the non-transparent electroplated coating layer and further comprises a semi-transparent or partially transparent or transparent electroplated coating film formed on an outside surface of the lampshade.

The outside surface of the above hollow decorative lampshade is provided, at different locations thereof, with semi-transparent electroplated coating films having different colors or different light transmittance levels.

The inside surface of the above hollow decorative lampshade is provided, at different locations thereof, with non-transparent electroplated coating films having different colors.

In the above hollow decorative lampshade, glue or adhesive is used to fix glitter or light-transmitting color paint having different colors between the inside surface of the lampshade and the non-transparent electroplated coating layer.

In the above hollow decorative lampshade, glue or adhesive is used to fix glitter or light-transmitting color paint having different shapes and sizes between the inside surface of the lampshade and the non-transparent electroplated coating layer.

The hollow lampshade can be used to cover or shade a light source of various lighting fixture and can be used in combination with various control circuits to provide a magic world of light of varying colors and illumination. Due to the thickness of the shell made of glass or light-transmitting plastics and different light transmission properties and refractive indexes of the inside surface coating film and the outside surface coating film, as well as the patterns formed with laser engraving on the non-transparent inside surface, different image effects can be induced in different layers, and this when combined with the decoration achieved with glitter or light-transmitting color paint, provides a better effect of eye catching.

An example of the embodiment of the present invention is a hollow decorative lampshade exhibiting an effect of multilayered image formation and can be mounted on a light-emitting household art work, a surface-supported decoration, a suspended decoration, or a lighting decoration or a base that comprises a light source to provide an effect of combination for various form.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart illustrating a manufacturing process according to the present invention.

FIG. 2 is a schematic view illustrating a lampshade made according to the manufacturing process of the present invention.

FIG. 3 is a cross-sectional view of a part of a lampshade made according to the manufacturing process of the present invention.

FIG. 4 is a cross-sectional view of a part of a lampshade made according to the manufacturing process of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a manufacturing process of a lampshade that provides an effect of showing a multilayered planar image exhibited through light illumination and transmission a glass or plastic surface and a product thereof.

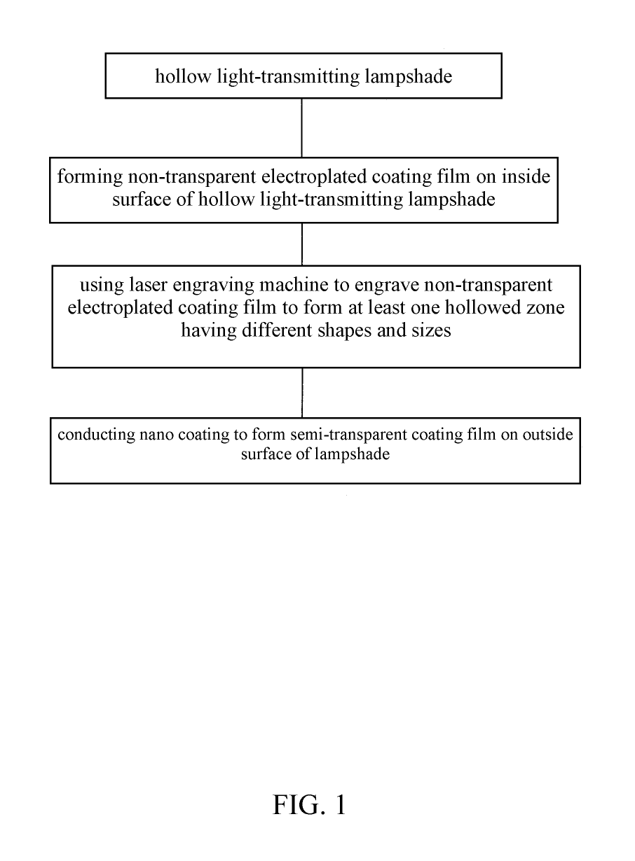

FIG. 1 is a flow chart illustrating a manufacturing process according to the present invention. The present invention provides a multilayered image transmitting lampshade manufacturing process and the product thereof and the manufacturing process is applied to a hollow, light-transmitting lampshade made of light-transmitting glass or light-transmitting plastics. An operation of non-transparent electroplated film coating is conducted on an inside surface of the lampshade first, and then a laser engraving machine is used to engrave at least one hollowed zone having different sizes and shapes in the non-transparent electroplated coating film. Finally, a transparent electroplated coating film is coated on an outside surface of the lampshade.

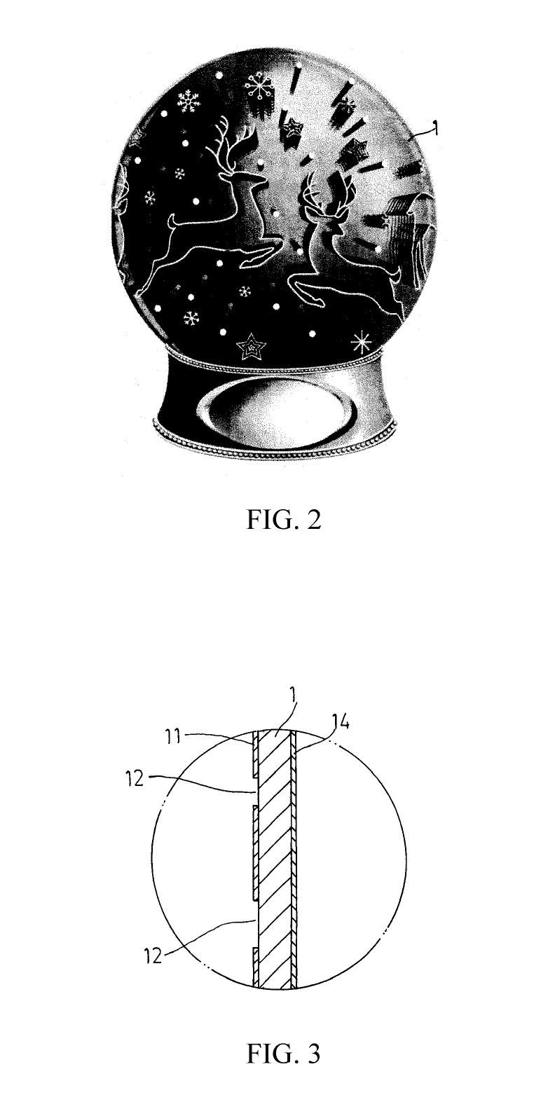

An embodiment of product is specifically illustrated in FIG. 2, which is a lampshade (1) that is hollow and provided for decorating a lighting device, providing an effect of showing a multilayered planar image exhibited through light illumination and transmission a surface and a product thereof. A main body of the hollow decorative lampshade (1) can be formed of light-transmitting glass or light-transmitting plastics and having different configurations. In the instant embodiment, the light-transmitting hollow decorative lampshade (1) comprise spherical body having a circular opening and an annular base that is integrally molded or otherwise combined with the circular opening. The light-transmitting hollow decorative lampshade (1) can be formed of light-transmitting glass that is colored or not colored, or can be formed of molding of plastics having high light transmittance. As shown in FIGS. 2 and 3, the hollow decorative lampshade (1) has an inside surface that is coated, through electroplating, with a non-transparent electroplated coating film (11), and the lampshade (1) has an outside surface that is coated, through electroplating, a transparent or a semi-transparent or partially-transparent electroplated coating film (14).

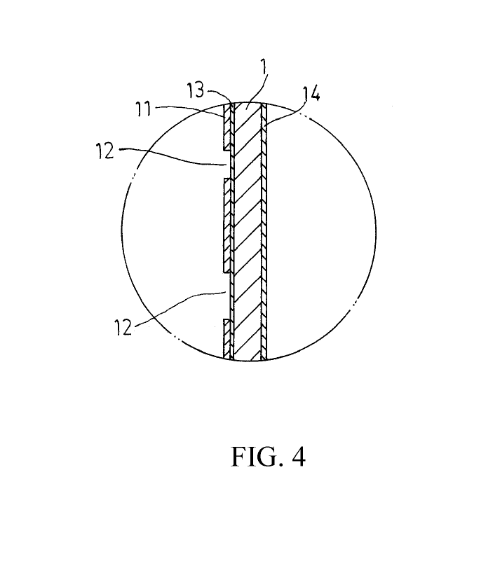

The non-transparent electroplated coating film (11) of the inside surface is machined with a laser engraving machine to form at least one hollowed zone (12) having different shapes and sizes. These hollowed zones (12) and the remaining non-hollowed zone(s) collectively form a desired pattern. As shown in FIG. 4, for a better effect of eye catching, glitter or light-transmitting color paint (13) is disposed and fixed, through application of glue or adhesive, between the inside surface of the lampshade (1) and the non-transparent electroplated coating film (11). The glitter or light-transmitting color paint (13) can be of different colors, shapes, and sizes for itself or the application thereof, in order to form a desired configuration of pattern. Similarly, the transparent or semi-transparent or partially-transparent electroplated coating film (14) provided on the outside surface of the lampshade (1) may be such that different portions thereof that have different colors or different levels of light transmittance are arranged on different zones of the outside surface. Next, a specific example of the manufacturing process of the multilayered image transmitting lampshade according to the present invention will be described.

Firstly, transparent glass or transparent plastics are molded with a mold or otherwise processed to form a lampshade, of which the shape and size can be determined or set according to requirements. Spherical shape is one feasible option.

Next, an operation is conducted to form a non-transparent electroplated coating film on an inside surface of the lampshade, followed by application of glue or adhesive on which glitter of multiple colors or colorful pearl-shining paint is sprayed. Next, a semi-transparent or partially-transparent electroplated nanometer coating film is applied to an outside surface of the lampshade so shaped or molded. The electroplated coating film on the inside surface is not light transmitting, while the electroplated coating film on the outside surface is semi-transparent or partially-transparent that is more light-transmitting, as compared to the inside surface coating. For coating films on both inside and outside surfaces, the colors of the coating films can be selected, wherein the inside surface coating film may be a single layer or may be composed of multiple layers of electroplated films having different colors stacked in an overlapped arrangement or in a non-overlapped arrangement or in a partially overlapped arrangement; and the outside surface coating film may be a single layer or may be composed of multiple layers of electroplated films having different colors stacked in an overlapped arrangement or in a non-overlapped arrangement or in a partially overlapped arrangement. Afterwards, a laser engraving machine is used to laser-engrave a pre-designed pattern on the inside of the lampshade. In the illustrative example, the lampshade is spherical and the electroplated layer(s) of the non-transparent coating film of the inside surface is machined such that portions thereof are removed according to the pre-designed pattern to form hollowed zones that collectively or partially constitute a desired pattern, with any damage caused on the surface of the product blank. The lampshade so completed would exhibit a stereoscopic effect of multiple layer image formation when light irradiates or illuminates the pattern.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A multilayered image transmitting lampshade manufacturing process, comprising providing a hollow light-transmitting lampshade formed of light-transmitting glass or light-transmitting plastics and having inside and outside surfaces, conducting an operation for forming a non-transparent electroplated coating film on the inside surface of the lampshade, using a laser engraving machine to engrave the non-transparent electroplated coating film to form at least one pattern comprising at least one hollowed zone having different shapes and sizes, and finally, conducting an operation to form a semi-transparent nanometer coating film on the outside surface of the lampshade.

2. A multilayered image transmitting lampshade product, comprising a hollow light-transmitting lampshade formed of light-transmitting glass or light-transmitting plastics, the lampshade having an inside surface on which a non-transparent electroplated coating layer is formed such that the non-transparent electroplated coating layer is machined with a laser engraving machine to form at least one hollowed zone that constitutes a patter, the lampshade having an outside surface on which a semi-transparent electroplated coating film is formed.

3. The multilayered image transmitting lampshade product according to claim 2, wherein the lampshade comprises glitter or light-transmitting color paint disposed and fixed, by means of glue or adhesive, between the inside surface of the lampshade and the non-transparent electroplated coating layer.

4. The multilayered image transmitting lampshade product according to claim 2, wherein the lampshade comprises a spherical body having an opening and an annular based combined with the opening, and the electroplated coating film comprises portions having different colors or different levels of light transmittance arranged on different zones of the outside surface of the lampshade.

5. The multilayered image transmitting lampshade product according to claim 2, wherein the non-transparent electroplated coating layer of the inside surface of the lampshade is of a silver color.

6. The multilayered image transmitting lampshade product according to claim 3, wherein the glitter or light-transmitting color paint fixed by glue or adhesive between the inside surface of the lampshade and the non-transparent electroplated coating layer comprises portions having different colors.

7. The multilayered image transmitting lampshade product according to claim 2, wherein the lampshade has different shapes and sizes.
